(19) United States
(12) Patent Application Publication
(10) Pub. No.: US 2003/0221403 A1
(43) Pub. Date: Dec. 4, 2003

(54) Method and apparatus for detachably mounting grass bag

(75) Inventors: Frank H. Hancock, Jackson, GA (US); Stephen C. Price, Barnesville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Snapper, Inc.

(21) Appl. No.: 10/394,411

(22) Filed: Mar. 21, 2003

Related U.S. Application Data
(60) Provisional application No. 60/366,730, filed on Mar. 22, 2002.

(51) Int. Cl. A01D 43/00

(52) U.S. Cl. 56/202

(57) ABSTRACT

A grass bag apparatus includes a bag portion, a lower bag attachment subassembly, and an upper bag attachment subassembly. The lower bag attachment subassembly includes a hoop portion and a handle portion. The upper bag attachment subassembly includes a first upper subportion element (itself including a main wireform subportion and hook portions) and a second upper subportion element (itself including a main wireform subportion and a shield portion). When the grass bag apparatus is attached to a convention lawnmower having a handle assembly, the lower bag attachment subassembly is mounted proximate the discharge opening of the lawnmower. The upper bag attachment subassembly is mounted proximate the handle assembly, particularly at a location including a crossbar. Hook portions being part of the first upper subportion element hook over the crossbar such that the first and second upper subportion elements tend to be locked together during such mounting on said crossbar.

### CROSS-REFERENCE TO RELATED APPLICATIONS

This application claims the benefit and priority of pending Provisional Application Serial No. 60/366,730, filed Mar. 22, 2002, entitled “WIRE FRAME GRASS BAGGER”. The entire contents of said application are likewise incorporated by reference.

### FIELD OF THE INVENTION

This invention pertains to the art of methods and apparatuses for use in lawn and garden care, and more specifically to methods and apparatuses for use in collecting lawn debris that has been cut by a walk-behind lawn mower. The present invention particularly relates to grass or other vegetation storage containers, or “grass bags”, used therewith.

### BACKGROUND OF THE INVENTION

Homeowners frequently collect and bag grass and other clippings generated when they mow their lawns. This practice is adopted to provide a lawn having a more finished and desirable appearance. If the grass clippings are not composted by the homeowner, generally they must be placed in a refuse can or bag for disposal.

Commonly, material collection bags attach to a discharge chute carried at the rear of walk-behind mowers and extend rearwardly behind them. The bags include an opening at their forward portion, which serves to receive clippings from the discharge chute and permit collected clippings to be emptied. It is often necessary to remove the grass bag so that the lawn debris can be discarded. After it is emptied the empty grass bag then is repositioned on the mower.

Many such “grass bags”, or other suitable containers, are known. Such bags include those shown in U.S. Pat. No. 5,033,258 to Lawn-Boy, as well as others.

However, improvements to such containers are always welcome, especially should they provide grass bags with suitable containment and emptying features at an acceptable price.

### SUMMARY OF THE INVENTION

The present invention generally relates to a lawn mower clippings bag which includes a mounting subassembly having improved features which maintain the rear end of the bag in a closed position when mounted.

### BRIEF DESCRIPTION OF THE DRAWINGS

Having thus described the invention in general terms, reference will now be made to the accompanying drawings, which are not necessarily drawn to scale, and wherein:

FIG. 1 is a pictorial view of a lawn mower 5 having a grass bag apparatus 10 attached thereto. This view is from behind and to the left of the mower 5. The bag portion 20 also is shown. The upper grass bag attachment subassembly 40 is also shown attached to the handle assembly 8.

FIG. 2 is a partial pictorial view of the grass bag apparatus 10, showing a portion of the bag portion 20, and the upper bag attachment subassembly 40, attached to the crossbar 9 of the handle assembly 8 of the lawnmower 5. The inclined frame members 6 of the handle assembly are also shown.

FIG. 3 is a partial pictorial view from a standpoint to the right and generally to the rear of the apparatus 10. The view includes a partial view of the upper bag attachment subassembly 40, and a partial view of the crossbar 9 and one inclined frame member 6. A portion of the grass bag 20 is also shown.

FIG. 4 is a partial pictorial view showing the upper bag attachment subassembly 40 detached from the handle assembly 8 of the lawnmower 5 with the upper bag attachment subassembly 40 opened by a user such that the interior of the bag may be accessed. Panel members “P” are likewise is shown in their partially folded configurations. This configuration could be the configuration just prior to opening or closing the bag.

FIG. 5 is a view that shows the handle portion 32 of the lower bag attachment subassembly 30 with the lower bag attachment subassembly 30 being detached from the discharge chute 6 of the lawnmower. As may be understood, the hooped portion of this subassembly is separated from the chute 6 by a sliding action by the user pulling upwardly and forwardly on the handle portion 32. This lower bag attachment subassembly could be as known in the art.

FIG. 6 is a view of a second embodiment upper bag attachment assembly 40, showing the two hook portions 43. It should be understood that a difference between the first and second upper bag attachment subassembly embodiments 40, 40′ is that the handles (the parts that are grasped) overlap and provide a locking configuration in the second embodiment 40′, whereas they are substantially parallel in the first embodiment 40 (see FIG. 2).

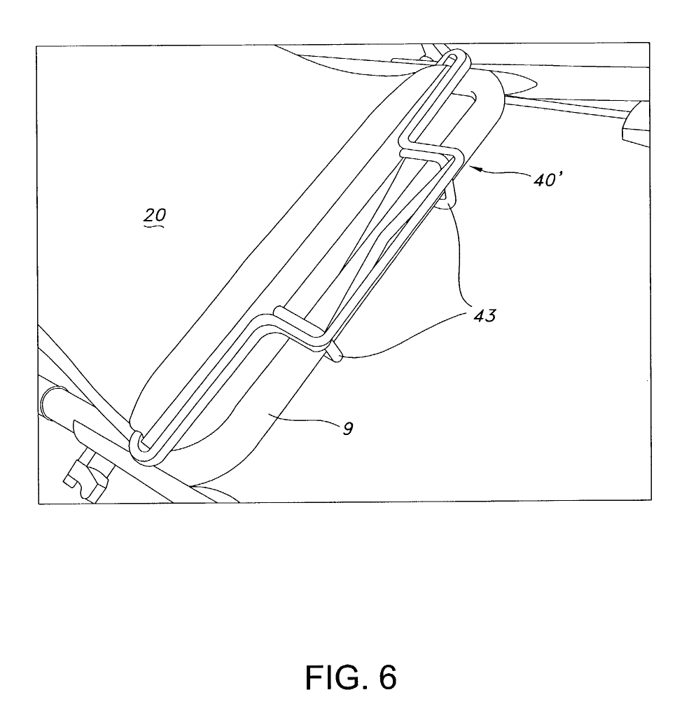

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The following are elements relating to the invention:

Lawnmower 5

Inclined Side Frame Members 6

Handle Assembly 8

Crossbar 9

Grass Bag Apparatus 10

Bag Portion 20

Lower Bag Attachment Subassembly 30

Hoop portion 31

Handle portion 32

Transverse wireform hanger member 35

Upper Bag Attachment Subassembly 40

First Upper Subportion 41

Main wireform subportion 42

Hook portions 43

Second Upper subportion 46

Main wireform subportion 47

Shield Portion 48

The grass bag apparatus 10 is configured to operate in conjunction with a typical lawn mower 5 having a rear discharge chute 6 defining a rearwardly-directed opening 7. The mower also includes a handle assembly 8 including a cross bar 9.

The Lawnmower

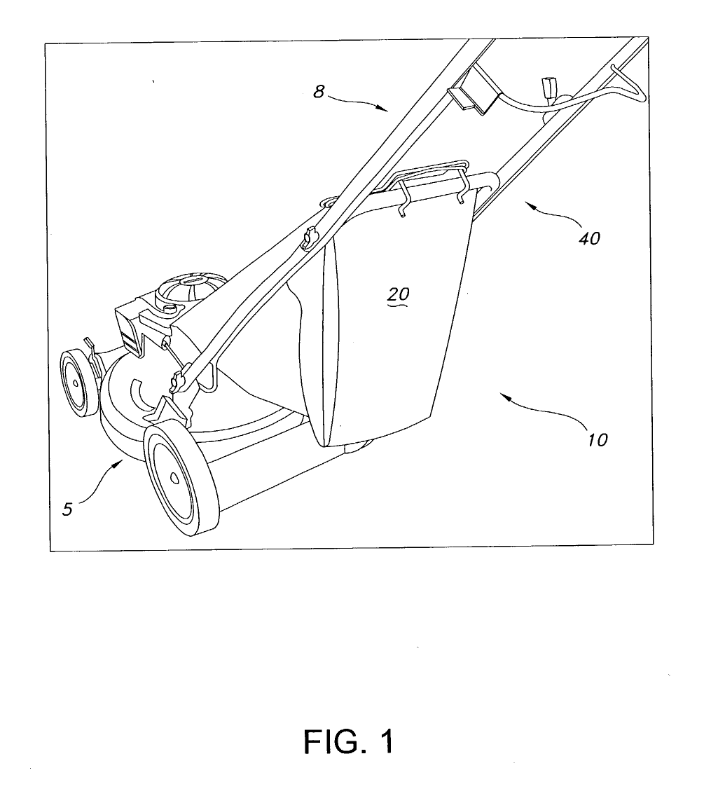

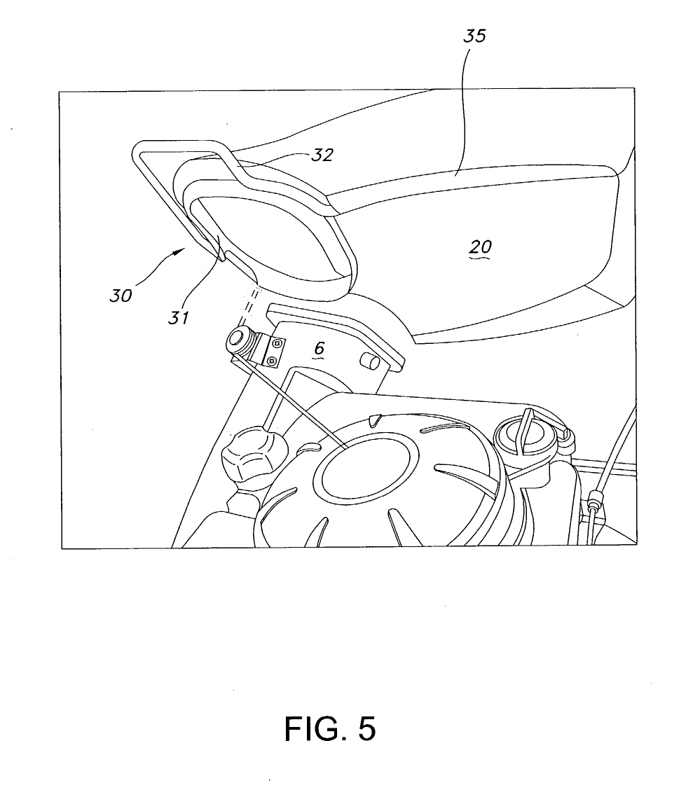

The lawnmower 5 (see FIG. 1) includes a discharge chute 6 (see FIG. 5), which is generally directed upwardly and rearwardly at an angle relative to horizontal. When the lawnmower 5 is operating, grass clippings are cut by an associated blade as known in the art, and detached grass clippings are blown through the rear discharge opening of the chute 6 of the lawnmower 5.

### General Construction and Operation

Grass Bag Apparatus 10

Generally described, the detachable clippings container 10 includes a flexible bag portion 20, a lower bag attachment subassembly (a.k.a. “and inlet end fastening assembly”) 30, and upper bag attachment subassembly (a.k.a. “discharge end fastening assembly”) 40.

Generally described, the assembly 10 is attached to a conventional walk-behind lawnmower such as 5 shown in FIG. 1.

The bag assembly 10 is attached to the lawnmower 5 generally at two locations, proximate the lower end and the upper end of the bag 10. The lower end is the location where the grass clippings enter the bag assembly 10 and the upper end is the end at which the grass clippings are discharged from the bag assembly 10. This discharge is selective, in that the user (not shown) can selectively discharge the clippings from the discharge end by detaching the assembly 10 from the lawnmower, opening the upper end of the bag assembly 10, and “dumping” discharging grass clippings or other vegetation from therein.

Bag Portion 20

The bag portion 20 is configured to accept grass or other vegetation clippings through an inlet and to store the clippings until discharge is deemed necessary.

The bag portion 20 is relatively flexible, and is made of flexible fabric or other suitable as known in the art.

However, the bag is not part of the present claimed invention.

Lower Bag Attachment Subassembly 30

The lower end of the bag assembly 10 includes a wireform assembly referenced as a lower bag attachment subassembly 30. This subassembly 30 includes a hoop portion 31, a handle portion 32 (See FIG. 5) and a hanger portion 35 (shown concealed in fabric). This subassembly 30 allows the lower end of the bag to be removably attached to the lawnmower 5 such that grass clippings can pass into the lower end of the bag assembly.

The hoop portion 31 defines an opening around which the lower flexible mouth of the bag may fit. In one embodiment this can be done by use of a flexible bag mouth opening which includes flexible string or rope inside, such that the opening may be stretched, passed over the hoop portion 31, and then allowed to retract snugly into place.

FIG. 5 also discloses the use of a transverse wireform hanger member 35 which is substantially elongate and has one end attached to the hoop portion 31 and extends generally horizontally, transversely, and leftwardly as the operator stands. This wireform member 35 extends within a corresponding sleeve sewn in the bag, and serves to hold the bag out in a more open position.

A “grasping handle portion” 32 is likewise facilitated (see FIG. 5), which extends generally upwardly relative to the mouth portion and provide a manner for a user (not shown) to grasp and disengage the assembly 30 and the attached lower end of the bag 20 from the chute 6 of the mower 5.

As will be discussed later in this application, the lower wireform assembly 30 is grasped by the user, and withdrawn from the discharge opening of the lawnmower, such that the lower end of the grass bag assembly 10 may be detached from the lawnmower.

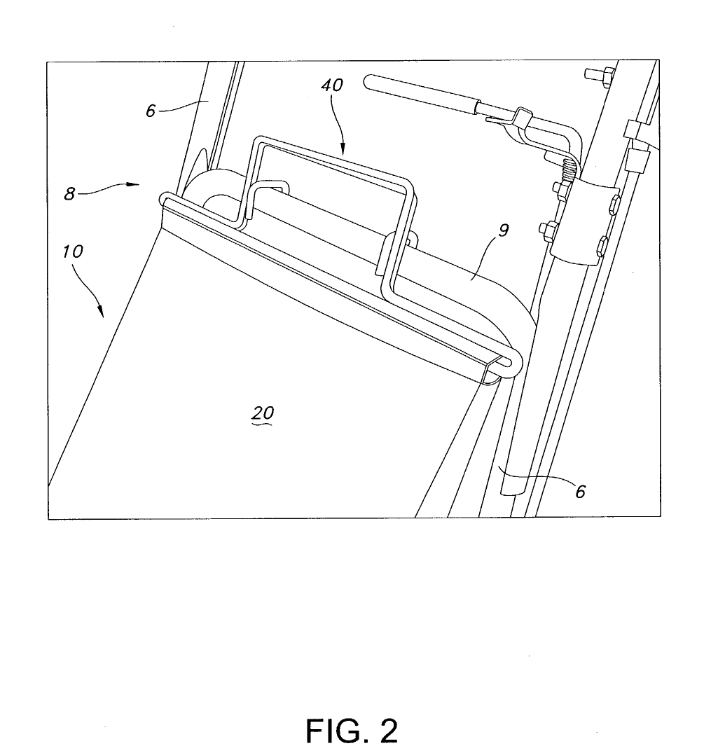

Upper Bag Attachment Subassembly 40 (See FIGS. 2, 3 and 4)

The upper end of the grass bag assembly 10 includes an upper bag attachment subassembly 40 which attaches the upper end of the bag 20 to the handle assembly 8 of the lawn mower, and also serves to provide a means for selective opening of the top of the bag so that it can be emptied as needed.

This assembly 40 generally includes two portions which can be selectively “attached” or “detached” to provide selective opening and closing, respectively, of the upper end of the grass bag assembly 10. These mating members shall be referenced as a first upper subportion member 41 and the second upper subportion member 46.

Both the first and second upper subportions are attached to different locations proximate the mouth of the flexible bag 20. The first upper subportion member 41 and the second upper subportion member 46 are both formed of metal or other suitably rigid material, thus the first and second upper subportions maintain respective edges of the mouth of the flexible bag in a straight configuration. When the subportions are together the straight portions “mate”. When the subportions are apart, the bellows shape of the upper opening (provided by the panels labeled “P”) of the bag provides for a readily closable opening. The “bellows” type mouth itself is conventional.

When the two members 41, 46, are separated such as shown in FIGS. 8 and 9, for example, the upper end of the bag is open and grass or other clippings may be discharged from the upper end of the bag by “dumping” the bag. When the members 41, 46, are attached as shown in FIG. 5, the upper end of the bag 20 is closed and the assembly 40 may be attached to the lawnmower handle assembly as shown.

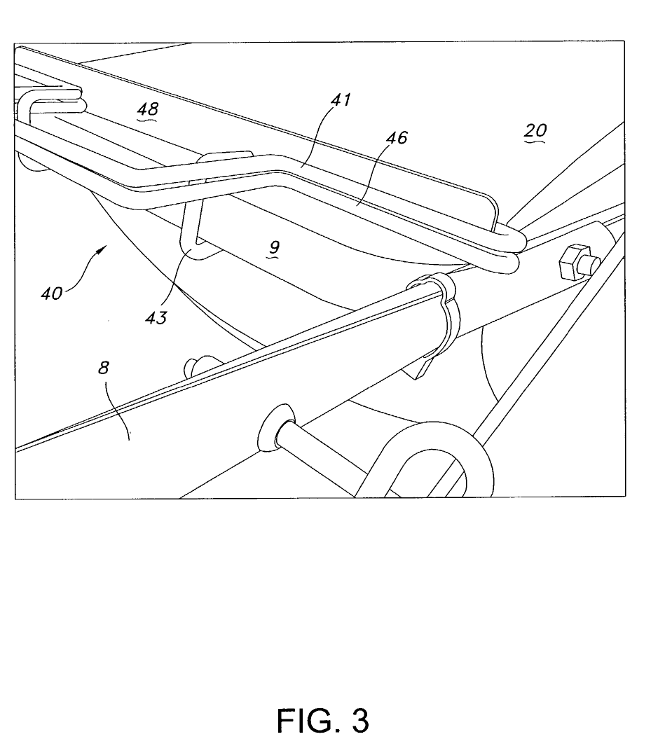

As may be seen in FIGS. 2 and 3, when in stalled the second upper subportion member 46 has its sidewardly-extending ends in contact with the inclined side frame members 6 of the handle assembly 8.

First Upper Subportion 41

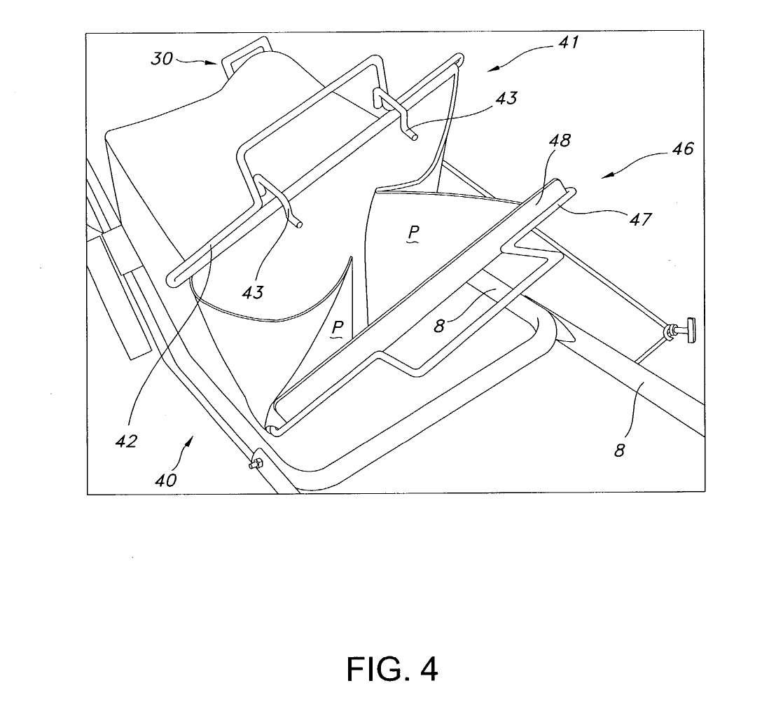

The first upper subportion member 41 is formed primarily of wireforms, and as shown in FIG. 4 includes a main wireform subportion 42 and a pair of hook members 43, each of which extends from the main subportion 42.

The pair of U-shaped “hook” members (or “portions”) 43 are configured to fit partially around the outer circumference of a horizontal cross member of the handle assembly of the lawn mower, such that the hook members attach to the cross member.

Second Upper Subportion 46

Continuing to refer to FIG. 4, the second upper subportion 46 includes a main wireform subportion 47, as well as a shield portion 48. This shield 48, as will be discussed later in this application, provides a shield for grass clippings or other suitable objects that might tend to pass out of the closed mouth of the bag 20.

Opening and Closing the Upper End of the Bag

To mate the two members 41 and 46 together, the barrier or shield portion 48 is situated such that one of its two long edges fits within a corresponding slot defined by the main wireform subportion 47 of the other member 42 as shown in FIG. 3. The two members 41, 46, are urged together so that they are “matched” or registered together, such as shown in FIG. 3.

When the members 41, 46, are positioned in their mating configurations, under one embodiment the wireforms substantially match on a “handle” portion of their lengths, such that a handle is provided that consists of two substantially parallel segments of wireform. This allows a person to grasp both of the members 41, 46, at the same time. At this point, the combined members 41, 46, (which together form the upper bag attachment assembly 40), may be grasped with one hand and attached to the handle assembly 7 of the lawnmower 5. However, it should be noted that there is an alternate preferred embodiment shown in 6, in which the handle portion of the second upper subportion 46 is not straight, but includes a slight, “broad V” shape which allows the V-shaped portion to fit underneath the handle portion of the first upper subportion member 41. This provides somewhat of a interlocking feature which allows causes a slight interlocking action between the two handle portions while their respective assemblies are being installed on the cross tube 9. As with the other “parallel handle” embodiment, once the combined members 41, 46, are installed the interaction of the handles, the hook portions 43, and the cross tube 9, provides a locking action as described elsewhere in further detail.

Removal Process

To remove the bag assembly 10 from the supporting lawnmower, the following process is used:

Assuming the user is standing to right side of the mower and facing the mower, the upper assembly 40 is grasped with the left hand of the user, and pulled first leftwardly and then upwardly. This movement is done so as to detach the hooks 43 from their respective engagement with the transverse horizontal cross member 9 of the handle assembly 8 of the lawnmower 5.

The lower bag attachment subassembly 30 is then removed from the lawnmower 5 by the user grasping the handle portion and pulling upwardly, such that the subassembly 30 is detached from the mower.

For reattachment, the lower assembly 30 is attached first followed by attachment of the upper assembly 40.

Attachment Process

It should be understood that the handle assembly 8 of the lawn mower 5 includes a horizontal transverse frame member 9, which extends generally transverse (a/k/a perpendicular) to the normal straight forward movement of the lawnmower. As may be understood, this horizontal cross member 9 in one configuration is made of tubular steel, (although other configurations are obviously contemplated under the present invention) and is structurally suitable for supporting the weight of the filled bag.

To attach the subassembly 40 to the member 9, the subportion 41 and the subportion 46 are matched together as noted elsewhere in this application. The combined members 41, 46 are then moved toward the handle 8, and the hook portions 43 are hooked over the cross bar 9. The upper bag attachment subassembly 40 is thus attached to the lawnmower 5.

It may be understood that, when the transverse cross member 9 is supporting the two members 41, 46, the transverse cross member is likewise “blocking” the movement of the first upper subportion member 41 from the coming out of engagement with the second upper subportion member 46, thus providing a locking action which preferably will not be disengaged until the two members are detached from the transverse cross member 9.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An upper bag attachment subassembly for use in conjunction with a lawn mower including a handle assembly including a substantially horizontal cross member and said lawn mower also including a grass bag including an upper and a lower end, said upper end of said grass bag including an upper bag opening including first and second edge portions, said upper bag attachment subassembly configured to attach said upper end of said grass bag relative to said handle assembly, said upper bag attachment subassembly comprising:
a first upper subportion element configured to be attached proximate said first edge portion of said upper bag opening, said first upper subportion element including at least one hook configured to attach to said horizontal cross member of said handle assembly; and
a second upper subportion element configured to be attached proximate said second edge portion of said upper bag opening,
said first and second upper subportion elements configured to cooperate together in at least two modes, an attached mode and a detached mode, said first and second upper subportion elements in said attached mode combining to mount said upper end of said grass bag relative to said handle assembly such that said hook of said first upper subportion element is attached to said horizontal cross member and said first and second edge portions of said upper bag opening are in a closed position tending to retain clippings within said grass bag, and said first and second upper subportion elements in said detached mode configured to be separated from each other and separated from said handle assembly such that said first and second edge portions of said upper bag opening are in an open position tending to allow clippings to be removed from said grass bag.

2. The upper bag attachment subassembly as claimed in claim 1, wherein said first and second upper subportion elements each includes a portion which attaches to said first and second edge portions, respectively, of said upper bag opening of said bag such that said first and second edge portions of said upper bag opening are each maintained in a substantially straight manner and such that said first and second substantially straight edge portions of said upper bag opening are each maintained in substantially parallel orientation while said first and second upper subportion elements are in said attached mode.

3. An upper bag attachment subassembly for use in conjunction with a lawn mower including a handle assembly including a substantially horizontal cross member and said lawn mower also including a grass bag including an upper and a lower end, said upper end of said grass bag including an upper bag opening including first and second edge portions, said upper bag attachment subassembly configured to attach said upper end of said grass bag relative to said handle assembly, said upper bag attachment subassembly comprising:
a first upper subportion element configured to be attached proximate said first edge portion of said upper bag opening, said first upper subportion element including at least one hook configured to attach to said horizontal cross member of said handle assembly; and
a second upper subportion element configured to be attached proximate said second edge portion of said upper bag opening,
said first and second upper subportion elements configured to cooperate together in at least two modes, an attached mode and a detached mode, said first and second upper subportion elements in said attached mode combining to mount said upper end of said grass bag relative to said handle assembly such that said hook of said first upper subportion element is attached to said horizontal cross member and contacts one side of said handle assembly, said second upper subportion element is in contact with an opposite side of said handle assembly, and said first and second edge portions of said upper bag opening are in a closed position tending to retain clippings within said grass bag, and said first and second upper subportion elements in said detached mode configured to be separated from each other and separated from said handle assembly such that said first and second edge portions of said upper bag opening are in an open position tending to allow clippings to be removed from said grass bag.

4. The upper bag attachment subassembly as claimed in claim 3, wherein said lawn mower includes a body and wherein said handle assembly has a length and has a lower end attached to said body, said handle assembly also having a width measured substantially transverse to the length of said handle assembly, and wherein said first upper subportion element has an elongate body portion having a length greater than the width of said handle assembly.

5. The upper bag attachment subassembly as claimed in claim 4, wherein said elongate body portion of said first upper subportion element has opposing ends, and wherein at least one of said opposing ends contacts said handle assembly when said first and second upper subportion elements are in said attached mode.

6. The upper bag attachment subassembly as claimed in claim 5, wherein said handle assembly includes a pair of inclined side members defining its width, and wherein at least one of said opposing ends contacts said inclined side members of said handle assembly when said first and second upper subportion elements are in said attached mode.

7. The upper bag attachment subassembly as claimed in claim 3, wherein said handle includes a pair of inclined side members defining its width, and wherein when said first and second upper subportion elements are in said attached mode, said second upper subportion element is in contact with at least one of said inclined side frame members.

8. The upper bag attachment subassembly as claimed in claim 3, wherein said first upper subportion element and said second upper subportion element fit together when in said attached mode such that said cross member is positioned between a portion of said hook member of said first upper subportion element and a portion of said secomd upper subportion element, such that the location of said cross member tends to prevent said first upper subportion element and said second upper subportion element from being separated.

9. The upper bag attachment subassembly as claimed in claim 3, wherein said first and second upper subportion elements each includes a body made of wireform and wherein said wireform bodies lie substantially in their own plane, and wherein said hook of said first upper subportion element passes through said plane of said second upper subportion element.

10. An upper bag attachment subassembly for use in conjunction with a lawn mower including a handle assembly including a substantially horizontal cross member and said lawn mower also including a grass bag including an upper and a lower end, said upper end of said grass bag including an upper bag opening including first and second edge portions, said upper bag attachment subassembly configured to attach said upper end of said grass bag relative to said handle assembly, said upper bag attachment subassembly comprising:
a first upper subportion element configured to be attached proximate said first edge portion of said upper bag opening, said first upper subportion element including a body and also including at least one hook configured to attach to said horizontal cross member of said handle assembly; and
a second upper subportion element configured to be attached proximate said second edge portion of said upper bag opening, said second upper subportion element including a shield portion,
said first and second upper subportion elements configured to cooperate together in at least two modes, an attached mode and a detached mode, said first and second upper subportion elements in said attached mode combining to mount said upper end of said grass bag relative to said handle assembly such that said hook of said first upper subportion element is attached to said horizontal cross member and contacts one side of said handle assembly, said second upper subportion element is in contact with an opposite side of said handle assembly, and said first and second edge portions of said upper bag opening are in a closed position tending to retain clippings within said grass bag and with said shield portion being oriented adjacent to and shielding said upper bag opening, and said first and second upper subportion elements in said detached mode configured to be separated from each other and separated from said handle assembly such that said first and second edge portions of said upper bag opening are in an open position tending to allow clippings to be removed from said grass bag.

11. The upper bag attachment subassembly as claimed in claim 10, wherein said lawn mower includes a body and wherein said handle assembly has a length and has a lower end attached to said body, said handle assembly also having a width measured substantially transverse to the length of said handle assembly, and wherein said first upper subportion element has an elongate body portion having a length greater than the width of said handle assembly.

12. The upper bag attachment subassembly as claimed in claim 11, wherein said elongate body portion of said first upper subportion element has opposing ends, and wherein at least one of said opposing ends contacts said handle assembly when said first and second upper subportion elements are in said attached mode.

13. The upper bag attachment subassembly as claimed in claim 12, wherein said handle assembly includes a pair of inclined side members defining its width, and wherein at least one of said opposing ends contacts said inclined side members of said handle assembly when said first and second upper subportion elements are in said attached mode.

14. The upper bag attachment subassembly as claimed in claim 10, wherein said shield is platelike, and wherein said first second upper subportion element defines an elongate slot configured to accept the thickness of said shield of said second upper subportion element when said first and second upper subportion elements are in said attached mode.

15. A method of using an upper bag attachment subassembly for use in conjunction with a lawn mower including a handle assembly including a substantially horizontal cross member and said lawn mower also including a grass bag including an upper and a lower end, said upper end of said grass bag including an upper bag opening including first and second edge portions, said upper bag attachment subassembly configured to attach said upper end of said grass bag relative to said handle assembly, said upper bag attachment subassembly comprising:
providing a first upper subportion element configured to be attached proximate said first edge portion of said upper bag opening, said first upper subportion element including at least one hook configured to attach to said horizontal cross member of said handle assembly;
providing a second upper subportion element configured to be attached proximate said second edge portion of said upper bag opening;
manipulating said first and second upper subportion elements to an attached mode such that said first and second upper subportion elements combine to mount said upper end of said grass bag relative to said handle assembly such that said hook of said first upper subportion element is attached to said horizontal cross member and contacts one side of said handle assembly, said second upper subportion element is in contact with an opposite side of said handle assembly, and said first and second edge portions of said upper bag opening are in a closed position tending to retain clippings within said grass bag; and
manipulating said first and second upper subportion elements to a detached mode such that they are separated from each other and separated from said handle assembly such that said first and second edge portions of said upper bag opening are in an open position tending to allow clippings to be removed from said grass bag.
